(19) United States
(12) Patent Application Publication
(10) Pub. No.: US 2014/0168078 A1
(43) Pub. Date: Jun. 19, 2014

(54) ELECTRONIC DEVICE AND INFORMATION PROCESSING METHOD

(71) Applicant: Kabushiki Kaisha Toshbia, Tokyo (JP)

(72) Inventors: Takahiro SUZUKI, Hamura-shi (JP); Ryuji SAKAI, Hanno-shi (JP); Kosuke HARUKI, Tachikawa-shi (JP); Akira TANAKA, Mitaka-shi (JP)

(73) Assignee: Kabushiki Kaisha Toshbia, Tokyo (JP)

(21) Appl. No.: 13/968,137

(22) Filed: Aug. 15, 2013

Related U.S. Application Data
(63) Continuation of application No. PCT/JP2013/059808, filed on Mar. 26, 2013.

(30) Foreign Application Priority Data
Nov. 5, 2012 (JP) 2012-243886

(51) Int. Cl. G06F 3/01

(52) U.S. Cl. CPC G06F 3/011
USPC 345/157

(57) ABSTRACT

According to one embodiment, electronic device including, shadow image generating module, shadow image position identification module, and output image processing module. Shadow image generating module configured to compare corrected image with original image and configured to generate shadow image. Shadow image position identification module configured to identify position on projection image designated by shadow image. Output image processing module configured to superimpose shadow image identified by shadow image position identification module on projection image and configured to output superimposed image.

### CROSS REFERENCE TO RELATED APPLICATIONS

This application is a Continuation Application of PCT Application No. PCT/JP2013/059808, filed Mar. 26, 2013 and based upon and claiming the benefit of priority from Japanese Patent Application No. 2012-243886, filed Nov. 5, 2012, the entire contents of all of which are incorporated herein by reference.

### FIELD

Embodiments described herein relate generally to an electronic device which is, for example, an information processing device, an information processing method, and a program.

### BACKGROUND

As an information processing device (an electronic device) that projects information, for example, a projector (a projection device) is widely used.

As methods for showing an arbitrary position in a projection image which is, for example, a document or a photograph projected by the projection device (the projector), there are a method for directly designating a predetermined position in a projection image by using a pointer or the like, a method for adding picture information such as a cursor display to information before projection that is held by the projection device, and others.

The method using the pointer or the like requires a pointing device. The method for adding the cursor display or the like to the information before projection requires an operation for moving the cursor display.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing an example of a processing system using an information processing device according to an embodiment;

FIG. 2 is an exemplary diagram showing an example of the information processing device according to an embodiment;

FIG. 3 is an exemplary diagram showing an example of an information processing method according to an embodiment;

FIG. 4 is an exemplary diagram showing an example (a standing position judgment) of the information processing method according to an embodiment;

FIG. 5 is an exemplary diagram showing an example (click identification) of the information processing method according to an embodiment;

FIG. 6 is an exemplary diagram showing an example of the information processing method according to an embodiment; and

FIG. 7 is an exemplary diagram showing an example of the information processing method according to an embodiment.

### DETAILED DESCRIPTION

Various embodiments will be described hereinafter with reference to the accompanying drawings.

In general, according to one embodiment, an electronic device comprising: a displacement correcting module configured to compare a position of an acquired projection image with that of an original image, correcting the position, and configured to obtain a perspective-transformed image; a color/luminance correcting module configured to compare a color or luminance of the perspective-transformed image with that of the original image, correcting the color or luminance, and configured to obtain a corrected image; a shadow image generating module configured to compare the corrected image with the original image and configured to generate a shadow image; a shadow image position identification module configured to identify a position on the projection image designated by the shadow image; and an output image processing module configured to superimpose the shadow image identified by the shadow image position identification module on the projection image and configured to output a superimposed image.

Embodiments will now be described hereinafter in detail with reference to the accompanying drawings.

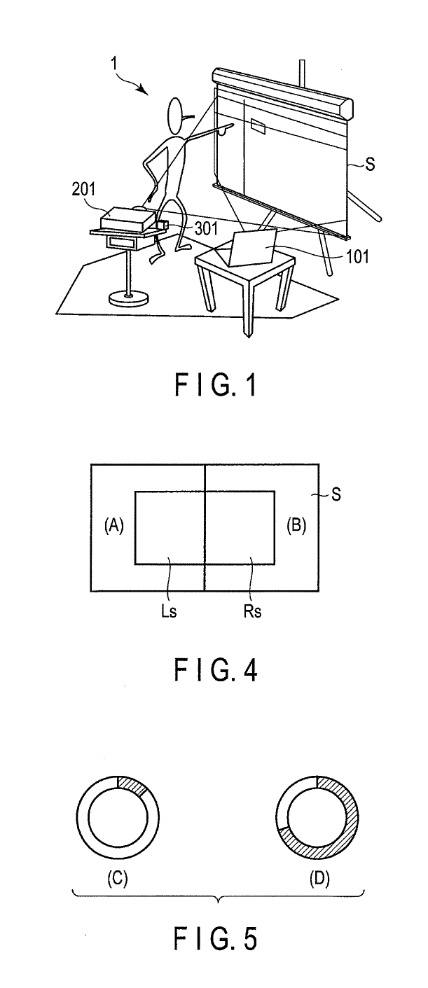

FIG. 1 shows an example of a projection system (an information processing system) using an information processing device (an electronic device) according to an embodiment. It is to be noted that elements, structures, or functions described below may be realized by hardware or they may be realized by software with the use of a microcomputer (a CPU or a processor) or the like.

A projection system 1 comprises: an electronic device, namely, an information processing device 101, a projection device 201 which outputs to, for example, a screen (a projection plane) a projection image associated with projection information output from the information processing device 101; and an imaging device 301 which acquires the projection image provided by the projection device 201. An operator can be placed at a predetermined position, for example, an arbitrary position on the left side or the right side of the screen (the projection plane) S. The operator does not have to be placed at a position where an image display provided by (a display screen integrally included in) the information processing device 101 can be seen, for example. The imaging device 301 may be integrated with, for example, the information processing device 101.

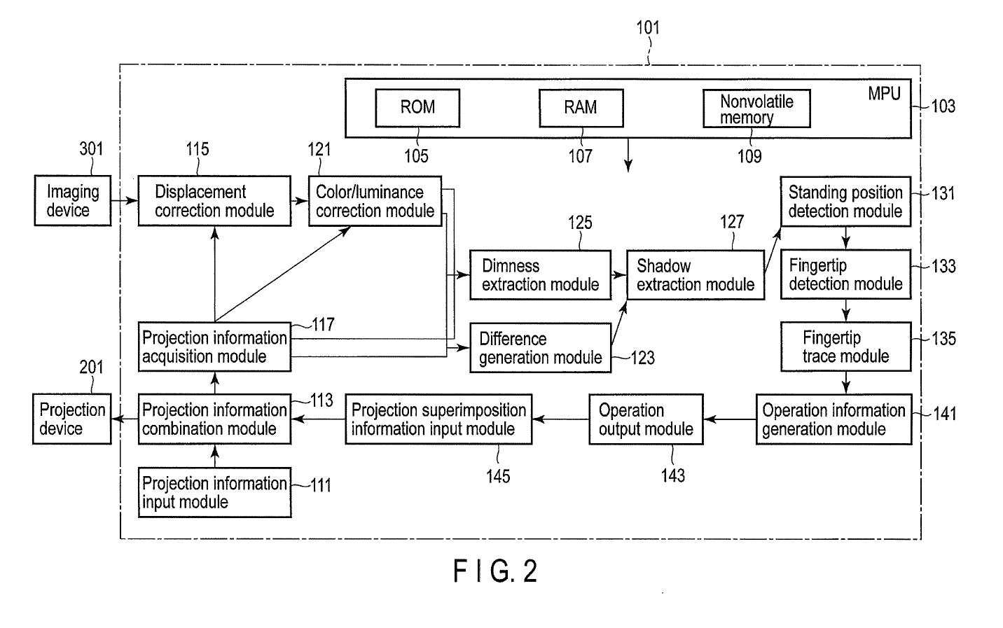

FIG. 2 shows an example of a configuration of the information processing device included in the projection system depicted in FIG. 1, for example, an electronic device which is a personal computer (PC) or the like.

The information processing device 101 comprises: a projection information combination module 113 to which projection contents are input through a projection information input module 111 which is, for example, an application or image processing software (software); a displacement correction module 115 that corrects a displacement of an acquired image obtained by using the imaging device 301 to acquire a projection image, which is projection information to be combined by the projection information combination module 113, projected by the projection device 201; and a projection information acquisition module (a screen capture function/screen capture module) 117 which acquires the projection information associated with the projection image projected by the projection device 201.

The information processing device 101 also comprises: a color or luminance correction module (which will be referred to as a color/luminance correction module hereinafter) 121 which corrects a color or luminance of a perspective-transformed image from the displacement correction module 115 to coincide with that of an original image; a difference generation module 123 which calculates a difference image Idiff(x,y)=|Ic(x,y)−Io(x,y)| by using a corrected image Ic(x,y) and the original image (a captured image) Io(x,y) supplied from the color/luminance correction module 121; a dimness extraction module 125 which calculates a dimness image Idim=threshold(Ic,<threshold value 1) from the corrected image Ic(x,y) and the original image (the captured image) Io(x,y) supplied from the color/luminance correction module 121, and a shadow extraction module 127 which calculates a shadow image Ishadow=threshold (Idiff*Idim,<threshold value 2) from an output from the difference generation module 123 and an output from the dimness extraction module 125.

The information processing device 101 also comprises: a standing position detection module 131 which judges which one of the left and right sides an operator is present (standing) on; a fingertip detection module 133 which detects a fingertip of the operator; and a fingertip trace module 135 which outputs a final fingertip position by using (the operator's) fingertip position information in the past.

The information processing device 101 further comprises: an operation information generation module 141 which detects that the final fingertip position has been pointing substantially the same position for a fixed time; an operation output module 143 which determines the final fingertip position as a cursor position, detects that the final fingertip position has been present for a fixed time (a period) to determine click (input determination), and also outputs an operation to the information processing device 101; and a projection superimposition information input module 145 which generates superimposition information which is to be combined with an image which is output from the operation output module 143 and to be combined in the image information combination module 113, i.e., the original image by overlay or the like.

It is to be noted that the information processing device 101 comprises: a control block (MPU) 103 that controls the above-described respective modules; an ROM 105 which holds programs that are used for operations of the MPU 103; an RAM 107 which functions as a work area in actual processing; a nonvolatile memory 109 which holds numerical data, applications, and the like; and others.

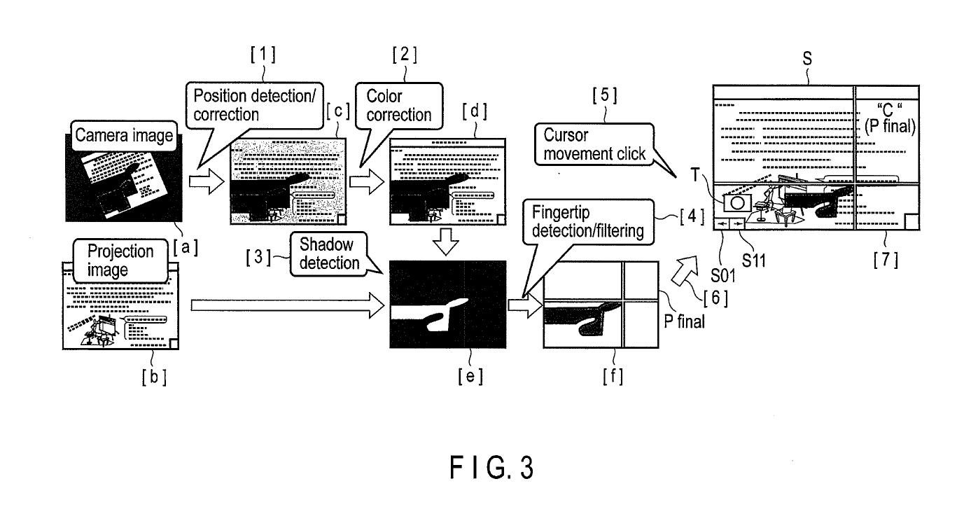

FIG. 3 shows an example of an operation in the projection system depicted in FIG. 1 and FIG. 2.

[[Displacement Correction]]

Projection contents are input to the projection information combination module 113 through the projection information input module 111, and the imaging device 301 acquires an image projected onto the projection plane by the projection device 201 (a projection plane image). An image acquired (obtained) by the imaging device 301 (which will be referred to as an acquired image hereinafter) is supplied to the displacement correction module 115 ([a] in FIG. 3).

The projection contents are also internally captured (acquired) in the projection information acquisition module 117 (by using, for example, a screen capture function of the PC 101) and supplied as an original image to the displacement correction module 115 ([b] in FIG. 3).

The displacement correction module 115 calculates which (type of) perspective transformation can be performed with respect to the acquired image so that the acquired image can coincide with the original image. For example, it extracts a local feature value such as SURF, performs cross-matching of the extracted local feature value, and estimates a nomography matrix which is a 3×3 matrix by using, for example, RANSAC ([1] in FIG. 3).

That is, an image output from the displacement correction module 115 ([c] in FIG. 3) is an acquired image subjected to the perspective transformation based on the homography matrix (which will be referred to as a perspective-transformed image hereinafter).

[[Color/Luminance Correction]]

The perspective-transformed image supplied from the displacement correction module 115 is fed to the color/luminance correction module 121 ([2] in FIG. 3).

Here, correction is carried out in such a manner that a color or luminance of the perspective-transformed image can coincide with that of the original image. For example, in each channel (or luminance) of all pixels, assuming that Ii (a value range is, for example, [0 . . . 255]) is a color or luminance of a pixel at a position (x,y) in the perspective-transformed image and Ij (a value range is, for example, [0 . . . 255]) is a color or luminance of a pixel at a position (x,y) in the original image, an average value m(Ij) of values of Ij which are taken in the original image by all points [(x,y)] that take a given value Ii in the perspective-transformed image is calculated, and this value is determined as a function f(Ii) that returns a corrected color or luminance to Ii. When the number of values of Ij corresponding to a certain value of Ii surrounding f(Ii) may be used and interpolated.

An image output from the color/luminance correction module 121 is obtained by applying f(i) to all pixels in the perspective-transformed image (which will be referred to as a corrected image hereinafter) ([d] in FIG. 3).

As a result, it is possible to cancel the influence of hues included in the original image and the acquired image each having a background which is usually substantially white, namely, colored components on the background produced in the projection image (an image that should be essentially white is slightly colored).

[[Generation of Shadow Image]]

The difference generation module 123 calculates a difference image Idiff(x,y)=|Ic(x,y)−Io(x,y)| by using the corrected image Ic(x,y) and the original image Io(x,y) supplied from the color/luminance correction module 121. Further, the dimness extraction module 125 calculates a dimness image Idim=threshold (Ic,<threshold value 1) by using a threshold value 1 ([3] in FIG. 3).

The shadow extraction module 127 calculates a shadow image Ishadow=threshold (Idiff*Idim,<threshold value 2) from Idiff and Idim by using a threshold value 2. In this regard, threshold (I,pred) is a function that produces an image which becomes 1 when a binary function pred is used in (x,y) and pred (I(x,y)) is achieved or becomes 0 in any other case.

This processing ([e] and [f] in FIG. 3) towards to detect an object and a shadow that are present between the projection plane (the screen) and the projection device 201 as Idiff, detecting dimness including the shadow as Idim, and extracting the shape by using a product of these detected members (the purpose is to extract the shadow).

[[Trace of Fingertip]]

In the standing position detection module 131, with regard to a shadow image, a sum of pixel values in each U-shaped portion shown in FIG. 4 is determined as Ls or Rs in accordance with each of a region (A) and a region (B). If Ls<Rs, the Rs side, i.e., the right side has more shadows. Therefore, if Ls<Rs, an operator is determined to be present on the right side (region (B)). If not, the operator is determined to be present on the left side (region (A)).

When the operator is present on the left side, the fingertip detection module 133 calculates Pf=(x,y) that allows x meeting Ishadow(x,y)>0 to become maximum. Furthermore, it calculates a ratio that realizes Ishadow(x,y)>0 in the range of surrounding [[threshold value 3]] pixels of Pf. If this ratio is smaller than [[threshold value 4]], Pf is sharp. As a result, [[Pf<threshold value 4]] is detected as a fingertip [4].

When the fingertip is detected, the fingertip trace module 135 appropriately executes filtering with fingertip position information in the past for removing noise and outputs a final fingertip position Pfinal.

For example, a Kalman filter which uses (x,x′,y,y′) as a state variable is adopted, and the filtering for removing noise is executed, thereby obtaining the final fingertip position Pfinal ([f] in FIG. 3).

[[Output of Operation]]

The operation information generation module 141 moves a cursor to the position of Pfinal ([5] in FIG. 3).

Here, for example, operation information is generated based on, for example, a rule that “click” is determined when Pfinal stays in a narrow range for a fixed period of time. Pfinal as a “cursor position”, “click information, “information required until click is determined”, or the like is supplied to the projection superimposition information input module 145 ([6] in FIG. 3).

At the same time, an operation for an actual device is carried out using the operation output module 143.

The information supplied to the projection superimposition information input module 145 is combined with the original image by the projection information combination module 113 based on, for example, overlay, and the combined image is supplied to the projection device 201 as a projection image in a subsequent frame.

At this time, on the screen (the projection plane) S are displayed an identification image which is the cursor C (Pfinal) or the like indicated as an intersection of two line segments crossing at a predetermined position in a displayed image, a “return” button display S01 which instructs to input a control command for displaying a previous page by “click”, a “next” button display S11 which instructs to input a control command for displaying a next page by “click”, a time display T which is explicitly shown by a technique of, for example, determining as a specified time corresponding to a circuit of a circle a time required for Pfinal (the intersection of two line segments) to be identified as a “cursor position” or “click information” (the time that should be maintained so that the position of the shadow of the fingertip does not move) and setting the color or brightness of a region corresponding to an elapsed time to be a different color or brightness with respect to the remaining time ([7] in FIG. 3).

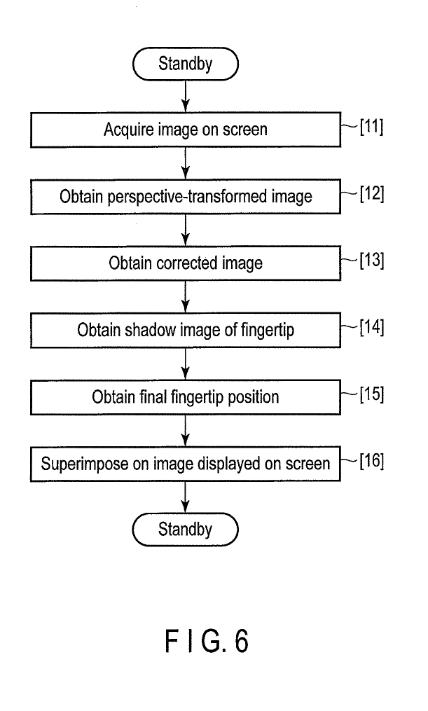

FIG. 6 shows the operation described in conjunction with FIG. 2 and FIG. 3 in terms of software.

First, a projection image on the screen S is acquired by a camera (the imaging device) 201 [11].

The position or distortion of the acquired projection image is corrected (a perspective-transformed image is obtained) [12].

A color, brightness (luminance), or the like of the perspective-transformed image is corrected (a corrected image is obtained) [13].

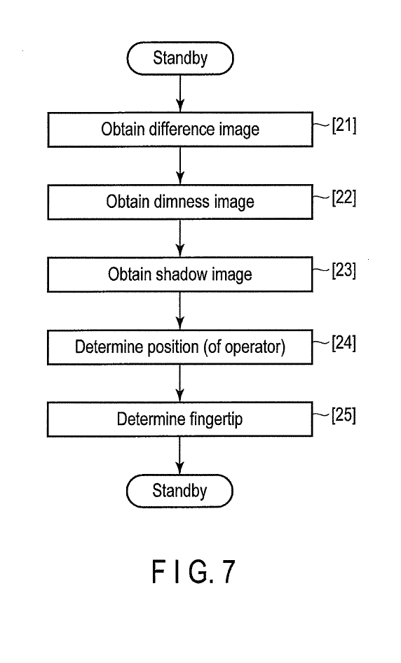

The corrected image is compared with a captured original image color are compared, and a shadow (a fingertip) image which will be described later with reference to FIG. 7 is obtained (a shadow image of the fingertip is obtained) [14].

The movement of the shadow image is traced, and the final fingertip position Pfinal is obtained [15].

A state that Pfinal does not move for a fixed time is detected, and an operation for displaying the cursor and others on an image that is actually displayed on the projection plane (superimposing the cursor display C and others on the display image) is carried out [16].

FIG. 7 shows the operation described with reference to FIG. 2 and FIG. 3 (the shadow image of the fingertip is obtained) in terms of software.

The corrected image Ic(x,y) and the original image Io(x,y) are used, and a difference image Idiff(x,y)=|Ic(x,y)−Io(x,y)| is calculated [21].

The threshold value 1 is used, and a dimness image Idim=threshold (Ic,<threshold value 1) is calculated [22].

The shadow image Ishadow=threshold (Idiff*Idim,<threshold value 2) is calculated from Idiff (the difference image) and Idim (the dimness image) by using the threshold value 2 [23].

A position of the operator is identified from the shadow image [24].

In association with the identified position of the operator, a ratio that realizes Ishadow(x,y)>0 in a range of surrounding [[threshold value 3]] pixels of Pf is calculated, and the ratio smaller than [[threshold value 4]] is identified as the fingertip [24].

With regard to the identified fingertip, the final fingertip position Pfinal is output [25].

As to the above-described processing, for example, following operations can be carried out.

(A) The threshold value 1, the threshold value 2, the threshold value 3, and the threshold value 4 are not only specified in advance, but they can be also dynamically adjusted depending on conditions during execution.

For example, the threshold value 1 can be increased when the environment is bright.

For example, when a light volume of the projector (the projection device 201) is small, the threshold value 2 can be reduced.

For example, when a shadow of a hand (the fingertip) is large, the threshold value 3 can be increased.

For example, when a finger of the operator is thick or when the shadow of the hand is small, reducing the threshold value 4 enables expanding further adaptable conditions.

(B) In generation of the shadow image, besides Idiff=|Ic(x,y)−Io(x,y)|, a tinge of dimness of Io(x,y) can be added.

For example, when Idiff=|Ic(x,y)−Io(x,y)|/(Io(x,y)+const.(constant)) is set, an accuracy for shadow detection in a portion with low luminance in the projection contents can be increased.

(C) In the projection image combination module 113, luminance of a portion where a graphic with low luminance and a large area is present can be increased so that such a graphic can be no longer present in the projection contents.

For example, transformation for linearly mapping the original luminance [0 . . . 255] to [20 . . . 255] can be considered. As a result, an accuracy for shadow detection in a portion with low luminance in the projection contents can be increased.

(D) When the imaging device takes a very long time to output information after input of this information to the projection device 201, the projection information acquisition module 117 may be configured to store several original images in advance and output a corresponding original image at the moment of imaging the information by the imaging device.

Therefore, it is possible to provide the electronic device, the information processing method, and the information processing program that realize designation with high visibility in combination with an operation of a designator who designates a position as a method for showing an arbitrary position in a projection image projected by the projection device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device medium comprising:
a displacement correcting module configured to compare a position of an acquired projection image with that of an original image, correcting the position, and configured to obtain a perspective-transformed image;
a color/luminance correcting module configured to compare a color or luminance of the perspective-transformed image with that of the original image, correcting the color or luminance, and configured to obtain a corrected image;
a shadow image generating module (123) configured to compare the corrected image with the original image and configured to generate a shadow image;
a shadow image position identification module (125) configured to identify a position on the projection image designated by the shadow image; and
an output image processing module (145) configured to superimpose the shadow image identified by the shadow image position identification module on the projection image and configured to output a superimposed image.

2. The electronic device of claim 1, wherein the displacement correcting module configured to compare the original image with the acquired projection image based on cross-matching of a local feature value and configured to obtain the perspective-transformed image.

3. The electronic device of claim 2, wherein the color/luminance correcting module configured to compare the color or luminance of the perspective-transformed image with that of the original image in accordance with each pixel and configured to correct the color or luminance.

4. The electronic device of claim 3, wherein the shadow image generating module configured to generate the shadow image based on a difference image obtained with regard to a difference between the corrected image and the original image and a dimness image obtained from the corrected image.

5. The electronic device of claim 1, wherein the shadow image position identification module configured to identify a direction and an end portion of the shadow image and configured to obtain a designated position identified by the shadow image.

6. The electronic device of claim 1, wherein a direction of the shadow image is judged based on a bilateral difference of the shadow image included in the acquired projection image.

7. The electronic device of claim 1, wherein the output image processing module configured to output a position of the identified image that is superimposed on the acquired projection image and the identified image to the designated position identified by the shadow image.

8. An information processing method comprising:
comparing a position of an acquired projection image with that of an original image, correcting the position, and generating a perspective-transformed image;
comparing a color/luminance of the perspective transferred image with that of the original image, correcting the color/luminance, and generating a corrected image;
comparing the corrected image with the original image and generating a shadow image;
identifying a position on the projection image designated by the shadow image; and
generating and outputting an output image obtained by superimposing the shadow image on the projection image.

9. A system configured to allow a computer to execute comprising:
a procedure of comparing a position of an acquired projection image with that of an original image, correcting the position, and generating a perspective-transformed image;
a procedure of comparing a color/luminance of the perspective transferred image with that of the original image, correcting the color/luminance, and generating a corrected image;
a procedure of comparing the corrected image with the original image and generating a shadow image;
a procedure of identifying a position on the projection image designated by the shadow image; and
a procedure of generating and outputting an output image obtained by superimposing the shadow image on the projection image.
